(19) United States
(12) Patent Application Publication
(10) Pub. No.: US 2021/0176968 A1
(43) Pub. Date: Jun. 17, 2021

(54) Pet Alert System

(71) Applicant: MaryEllen Bager, West Seneca, NY (US)

(72) Inventor: MaryEllen Bager, West Seneca, NY (US)

(21) Appl. No.: 17/118,880

(22) Filed: Dec. 11, 2020

Related U.S. Application Data
(60) Provisional application No. 62/947,896, filed on Dec. 13, 2019.

(51) Int. Cl. A01K 29/00

(52) U.S. Cl. CPC A01K 29/005; F16M 13/022

(57) ABSTRACT

A pet alert system is provided. The pet alert system includes an elongated base. The elongated base includes a fastener. The fastener is used to attach the elongated base to a vertical surface. A number of actuators are placed on the bottom end of the elongated base. The actuators may be connected at least one sensor. When connected to the actuator, the sensor is, in turn, connected to a wireless signal transceiver. The wireless signal transceiver is designed to emit a wireless signal when the sensor is activated by an actuator.

### CROSS REFERENCE TO RELATED APPLICATIONS

This application claims the benefit of U.S. Provisional Application No. 62/947,896 filed on Dec. 13, 2019. The above identified patent application is herein incorporated by reference in its entirety to provide continuity of disclosure.

### BACKGROUND OF THE INVENTION

The present invention relates to a pet alert system. More specifically, the present invention could provide a physical mechanism by which a pet may interact to send an alert to his or her owner.

Many people own pets because they enjoy the companionship or security that having domesticated animals in their homes provides. For example, many individuals own pets such as dogs, cats, or the like. These types of pets generally have sufficient mobility and freedom within their homes to move around as desired. Owning a pet is a responsibility that requires regular actions to be taken by the owner. In order to be a responsible pet owner, one must provide food, water, bedding, exercise, bathroom trips and entertainment to his or her pets in order to keep the pets happy and healthy. In the course of a pet owner's daily life, however, it is possible that he or she may become distracted and forget to provide their pet with a necessary resource or activity. When this happens, an accident can result, such as the pet urinating or defecating on the floor or the pet could damage the pet owner's belongings if they are not hungry, thirsty or otherwise unhappy. This type of damage can be expensive or time-consuming to remedy. Furthermore, it is unhealthy for pets to have to restrain themselves from going to the bathroom for prolonged periods of time.

To prevent these types of situations from occurring, many pet owners will utilize various types of pet notification devices or will monitor their pets' behaviors as adequately as they are able to. Pets that are mentally or physically disabled may require an even higher level of attention from their owners. Most pet notification devices still require the pet owner to actively monitor their pet at some level, not necessarily preventing the pet owner from becoming distracted and forgetting to monitor their pet. Many passive monitoring systems are also ineffective as they may require a high level of understanding by the pet to directly engage them in a difficult or complex manner. Many pets may be unable to learn how to activate a singular pet alert device (such as a bell) without a prolonged period of training. Furthermore, many of these existing devices fail to provide options for hearing-impaired or sight-impaired pet owners.

Therefore, there is a defined need amongst the known prior art references for a pet alert device that allows for the pet owner to passively monitor when his or her pet needs attention. The device may be capable of providing a notification that is accessible remotely and by hearing-impaired or visually-impaired pet owners.

### SUMMARY OF THE INVENTION

In view of the foregoing disadvantages inherent in the known types of pet monitoring and alert devices and methods now present in the prior art, the present invention provides a pet alert device wherein the same can be utilized for providing convenience for the user when alerting a pet owner to a need for attention by his or her pet.

The present system comprises an elongated base. The elongated base comprises at least one fastener. The fastener, or fasteners, is configured to secure the elongated base to a vertical surface. A plurality of actuators is disposed on a bottom end of the elongated base. The plurality of actuators is provided at a location such that they can be engaged by a pet. Each actuator of the plurality of actuators may be in operable connection with at least one sensor. The plurality of sensors, when present, is in operable connection with a wireless signal transceiver. The wireless signal transceiver is configured to emit a wireless signal in response to a sensor of the plurality of sensors being activated. The sensors are activated when an actuator of the plurality of actuators is actuated.

### BRIEF DESCRIPTION OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a block diagram of an embodiment of the pet alert system.

FIG. 2 shows a perspective view of an embodiment of the pet alert system.

FIG. 3 shows a close-up view of a rear surface of an embodiment of the pet alert system.

FIG. 4 shows a perspective view of an embodiment of the pet alert system in use.

### DETAILED DESCRIPTION OF THE INVENTION

Reference is made herein to the attached drawings. Like reference numerals are used throughout the drawings to depict like or similar elements of the pet alert system. The figures are intended for representative purposes only and should not be considered to be limiting in any respect.

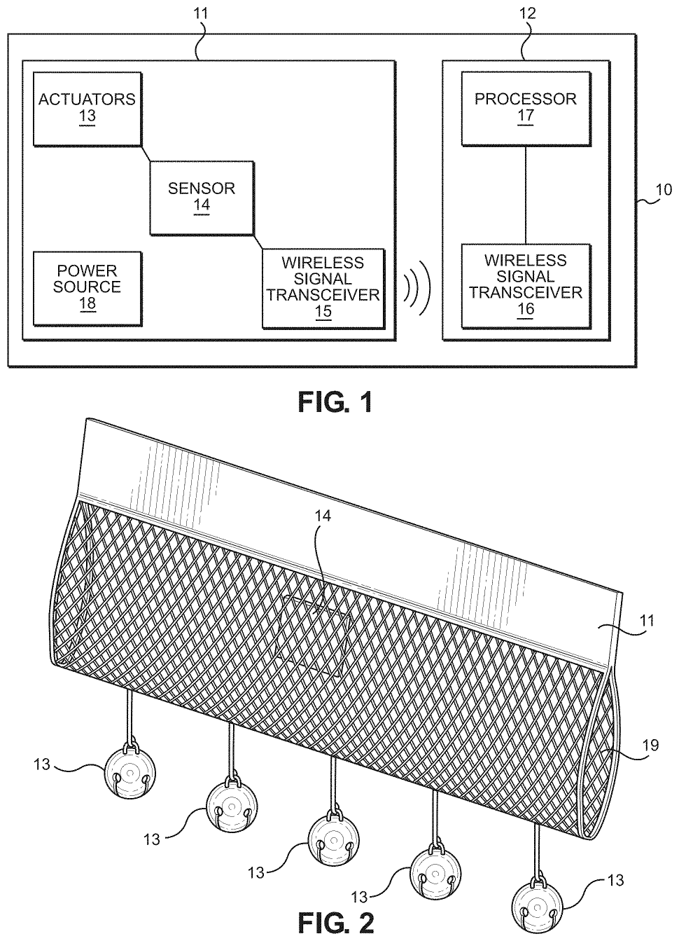

Referring now to FIG. 1, there is shown a block diagram of an embodiment of the pet alert system. The pet alert system 10 comprises an elongated base 11. The elongated base 11 is configured to secure directly to a desired location. The desired location, as contemplated, will be a vertical surface that is accessible by a pet. In the illustrated embodiment, the pet alert system 10 further comprises a mobile device 12. The elongated base 11 is in operable connection with the mobile device 12, such that information can pass from the elongated base 11 to the mobile device 12.

The elongated base 11 comprises a plurality of actuators 13. The actuators 13 are of any suitable structure, size and configuration to be engaged by the pet when the pet desires to alert the user to their need for attention. For example, the plurality of actuators 13 may comprise a plurality of bells or a plurality of buttons that are configured to be activated by the pet. The actuators 13 are configured to provide a pet-friendly mechanism by which the pet can interact with the elongated base 11 via a controlled action by the pet, such as swiping the actuator 13 with a paw or manipulating the actuator 13 with a nose.

In some embodiments, the plurality of actuators 13 are in operable connection with at least one sensor 14. The sensor, or sensors, 14 are of any suitable design and configuration for sensing the controlled action performed upon an actuator of the plurality of actuators 13. Additionally, the sensor 14 may be configured to sense direct contact with or movement of the sensor 14, such that a controlled action that is not detected by the plurality of actuators 13 may be detected by the sensor 14 if the sensor 14 itself is moved or touched.

In the demonstrated embodiment, the sensor 14 is in operable connection with a wireless signal transceiver 15. The wireless signal transceiver 15 is configured to transmit a wireless signal when the sensor 14 detects activation of an actuator 13 and/or the sensor 14 itself. In some embodiments, the wireless signal transceiver 15 may be confined to the same housing as the sensor 14. When a wireless signal is transmitted from the wireless signal transceiver 15, the wireless signal is configured to be detected and received by a wireless signal receiver 16 that is in operable connection with the mobile device 12. In the illustrated embodiment, the elongated base 11 further comprises a power source 18. The power source 18 is configured to supply power to the components of the elongated base 11 including the actuator 13 (if necessary), the sensor 14 and the wireless signal transceiver 15.

The mobile device 12 comprises a processor 17 in operable connection with the wireless signal receiver 16. The processor 17 is, among other functions, configured to run and execute an application. The application is configured to emit an alert upon the display of the mobile device 12, when the processor 17 detects that a wireless signal has been received by the wireless signal receiver 16 from the wireless signal transceiver 15 of the elongated base 11. As such, the user will be notified through the mobile device 12 when the plurality of actuators 13 are engaged by the pet of the user.

Referring now to FIG. 2, there is shown a perspective view of an embodiment of the pet alert system. The elongated base 11, as shown, is rectangular in shape. Ideally, the elongated base 11 will be dimensioned such that it can be mounted upon a vertical surface, such as a door, as desired by the owner of the pet. In some embodiments, the elongated base 11 is extendable, such that the user may adjust the length of the elongated base 11, making it so that the elongated base 11 may be applied to multiple different vertical surfaces. Structurally, the elongated base 11 may be extendable and contractable by any known mechanism. For example, the elongated base 11 may be telescopic or may consist of a plurality of attachable and detachable segments. Furthermore, in some embodiments, the elongated base 11 may be foldable, such that the elongated base 11 may be stored and transported easier.

The elongated base 11 further comprises a plurality of actuators 13. The plurality of actuators 13 extend downward from the elongated base 11, such that they may be accessible from the area below the elongated base 11. The plurality of actuators 13, as shown, may be movably affixed to the elongated base 11, such that they may be more easily moved and actuated when they are engaged by the pet. For example, the plurality of actuators 13 may be connected to the elongated base 11 via a connector ring. In the illustrated embodiment, the plurality of actuators 13 consists of a plurality of bells. The plurality of bells provides an actuator 13 that independently creates an audible noise when engaged by the pet. As such, in addition to engaging the sensor 14, the plurality of bells creates a separate audible alert to the pet owner in the area of the elongated base 11.

In the illustrated embodiment, the elongated base 11 further defines a tubular channel 19 extending downward therefrom. As shown, the tubular channel 19 runs parallel to the elongated base 11. Ideally, the tubular channel 19 is constructed of a semi-rigid material, such that the tubular channel 19 is maintained in a generally opened position (as shown). For example, the tubular channel 19 may be constructed of a plastic crochet lattice material, as shown in the illustrated embodiment. This allows for the tubular channel 19 to be provided at a space outward from the vertical surface on which the elongated base 11 is mounted. As such, the risk of damage to the vertical surface is reduced when the pet engages the plurality of actuators 13 or the tubular channel 19 itself.

In the demonstrated embodiment, the plurality of bells is placed on the bottom of the tubular channel 19. As such, the plurality of bells is placed outward at a defined distance from the vertical surface on which the elongated base 11 is mounted to allow for a more effective reverberation of the plurality of bells, Additionally, in the illustrated embodiment, the sensor 14 is internally placed upon an outer side of the tubular channel 19. As such, when the tubular channel 19 itself is engaged by the pet, the plurality of bells is engaged, or in embodiments having a wireless transceiver, the sensor 14 will detect the motion of the tubular channel 19, engaging the wireless signal transceiver to send the alert to the mobile device.

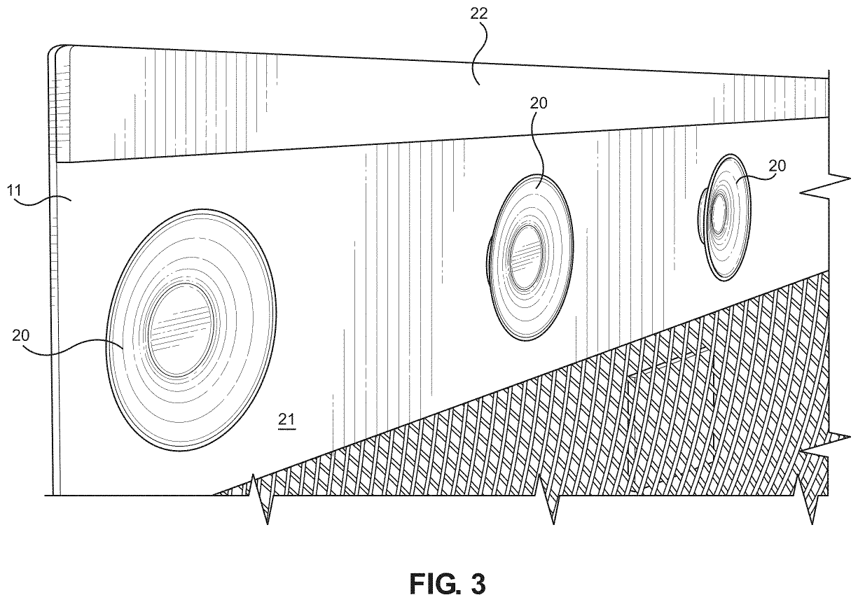

Referring now to FIG. 3, there is shown a close-up view of a rear surface of an embodiment of the pet alert system. The elongated base 11 further comprises at least one fastener 20. The fastener, or fasteners, 20 is/are placed on the rear surface 21. of the elongated base, such that the fastener 20 may be utilized to secure the elongated base 11 to a vertical surface, such as a door or a wall. In the illustrated embodiment, the fastener20 comprises a plurality of suction cups that are evenly placed along the length of the elongated base 11. Furthermore, in the demonstrated embodiment, a spacer 22 is also disposed on the rear surface 21 of the elongated base 11 in order o reduce the impact of the elongated base upon the vertical surface. In alternate embodiments, the fastener 20 may comprise a hook and loop fastener. The choice of fastener varies and may depend on the door structure or other considerations.

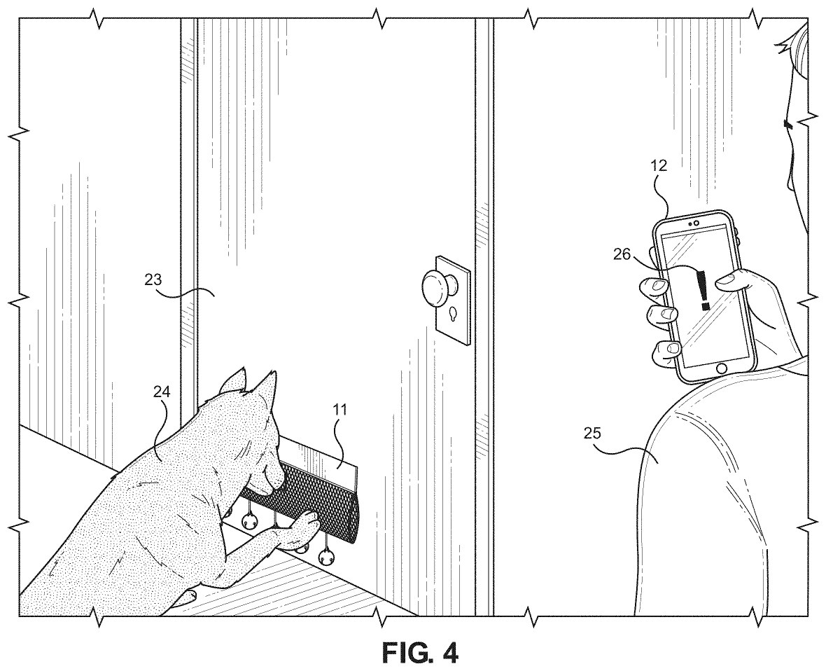

Referring now to FIG. 4, there is shown a perspective view of an embodiment of the pet alert system in use. In use, the pet alert system is utilized to provide a mechanism by which the pet 24 may be passively monitored by the pet's owner 25. In the demonstrated embodiment, the elongated base 11 is affixed to a door 23 via engagement of tine fasteners with the door 23. When the pet 24 is in need of attention, it will, having been conditioned, engaged the plurality of actuators and/or the sensor, Upon engagement of the plurality of actuators and/or the sensor, the wireless signal transceiver will transmit a signal from the elongated base 11 to the mobile device 12 of the user. The mobile device 12 will then provide a visual alert 26, or a sounding alert, upon the display of the mobile device 12 to alert the pet's owner 25 that the pet 24 is in need of attention.

It is therefore submitted that the instant invention has been shown and described in various embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

1) A pet alert, comprising:
an elongated base;
the elongated base comprising at least one fastener;
a plurality of actuators disposed on a bottom end of the elongated base.

2) The pet alert system of claim 1, wherein:
the plurality of actuators is in operable connection with at least one sensor;
the at least one sensor is in operable connection with a wireless signal transceiver;
the wireless signal transceiver is configured to emit a wireless signal when a sensor of the plurality of sensors is activated via an actuator of the plurality of actuators.

3) The pet alert system of claim 2, further comprising a mobile device, the mobile device comprising a wireless signal receiver.

4) The pet alert system of claim 3, wherein the mobile device comprises an application configured to generate a notification when the wireless signal is received by the wireless signal receiver.

5) The pet alert system of claim 1, wherein the fastener comprises a plurality of suction cups disposed on a rear surface of the elongated base.

6) The pet alert system of claim 1, wherein the fastener comprises a hook and loop fastener disposed on a rear surface of the elongated base.

7) The pet alert system of claim 2, wherein a power source is disposed upon the elongated base.

8) The pet alert system of claim 1, wherein the plurality of actuators consists of a plurality of

9) The pet alert system of claim 1, wherein the elongated base defines a tubular channel extending downward therefrom, wherein the plurality of actuators are disposed on a bottom edge of the tubular channel.

10) The pet alert system of claim 9, wherein the plurality of actuators extend downward from the tubular channel.

11) The pet alert system of claim 9, wherein the tubular channel is formed of a semi-rigid material.

12) The pet alert system of claim 9, wherein the tubular channel is formed of a plastic crochet lattice material.

13) The pet alert system of claim 1, wherein each actuator of the plurality of actuators is movably affixed to the elongated member.

14) The pet alert system of claim 1, wherein the fastener is configured to secure the pet alert system to a door.

15) The pet alert system of claim 1, wherein the elongated member is extendable.

16) The pet alert system of claim 1, wherein the elongated member is foldable.
